(19) United States
(12) Patent Application Publication
(10) Pub. No.: US 2025/0362953 A1
(43) Pub. Date: Nov. 27, 2025

(54) COMPARATIVE PERFORMANCE ASSESSMENT OF GENERATIVE ARTIFICIAL INTELLIGENCE MODELS

(71) Applicant: NVIDIA Corporation, Santa Clara, CA (US)

(72) Inventor: Rafid Mahmood, Mississauga (CA)

(21) Appl. No.: 19/216,149

(22) Filed: May 22, 2025

Related U.S. Application Data
(60) Provisional application No. 63/651,811, filed on May 24, 2024.

(51) Int. Cl. G06F 9/48

(52) U.S. Cl. CPC G06F 9/4881

(57) ABSTRACT

Disclosed are apparatuses, systems, and methods, for generative artificial intelligence analysis and improvement. The systems and methods may analyze a plurality of outputs produced by a first generative AI model for using a plurality of input options for performing each task of a plurality of tasks. The system may then compare first performance data reflecting a first subset of input options selected from the plurality of input options used by the first generative AI model for at least one task of the plurality of tasks and second performance data reflecting a second subset of input options used by a second generative AI model for the at least one task. Based on a comparison of the first performance data and the second performance data, the systems and methods may generate a recommendation related to a use of the first generative AI model.

### CROSS-REFERENCE TO RELATED APPLICATION(S)

The present application claims the benefit of U.S. Patent Application No. 63/651,811, filed on May 24, 2024, the entire contents of which are hereby incorporated by reference herein.

### BACKGROUND

Classical machine learning (ML) technologies traditionally execute one task. Each classical ML technology is then enabled to focus on a corner of technological space for ML model comparison and innovation. The increasing use of generative artificial intelligence (AI) models enables a single model to be used for multiple tasks. For example, a single generative AI model can write code, draft emails, generate images, summarize information, and the like. With so many varied tasks, it can be difficult to evaluate and/or predict the quality of the generative AI model performance. Further, tasks of the generative AI model valued by AI model providers may not be the same tasks that are valued by users upon use. Discrepancies in valuation can lead to waste in computational resources for distribution and execution for the generative AI model.

### BRIEF DESCRIPTION OF THE DRAWINGS

To easily identify the discussion of any particular element or act, the most significant digit or digits in a reference number refer to the figure number in which that element is first introduced.

FIG. 1 is a schematic block diagram of an example generative AI task-based performance assessment system architecture for analyzing the performance metrics of each task by the generative AI model, according to at least one embodiment;

FIG. 2 is a flow diagram for reviewing and analyzing the performance metrics of each task by the generative AI model using the generative AI task-based performance assessment system of FIG. 1, according to at least one embodiment;

FIG. 3 illustrates an example graph for relative performance metrics between generative AI models on different tasks and user demand taken by one task, according to at least one embodiment;

FIG. 4A illustrates an example graph for demand based on price per prompt for tasks executed using the generative AI model, according to at least one embodiment;

FIG. 4B an example graph for revenue based on price per prompt for tasks executed using the generative AI model, according to at least one embodiment;

FIG. 5 is a flow diagram of an example method of generative AI task-based performance assessment systems, according to at least one embodiment;

FIG. 6A illustrates inference and/or training logic, according to at least one embodiment;

FIG. 6B illustrates an aspect of the subject matter in accordance with one embodiment.

FIG. 7 illustrates training and deployment of a neural network, according to at least one embodiment;

FIG. 8 is an example data flow diagram for an advanced computing pipeline, according to at least one embodiment;

FIG. 9 is a system diagram for an example system for training, adapting, instantiating, and deploying machine learning models in an advanced computing pipeline, according to at least one embodiment;

FIG. 10A is a block diagram of an example generative language model system suitable for use in implementing at least some embodiments of the present disclosure;

FIG. 10B is a block diagram of an example embodiment in which the generative LM includes a transformer encoder-decoder, according to at least one embodiment;

FIG. 10C is a block diagram of an example embodiment in which the generative LM includes a decoder-only transformer architecture, according to at least one embodiment; and

FIG. 11 is a block diagram of an example computing device suitable for use in implementing some embodiments of the present disclosure.

### DETAILED DESCRIPTION

Aspects of the present disclosure are related to providing a generative artificial intelligence (AI) model task-based performance assessment. In some situations, when first providing the generative AI model to users, it can be important to assess performance of the generative AI model. This assessment can be difficult in a field that is as quickly developing as generative AI. Often, a model may be released that is the first of a kind and no relative task performance can be determined. In some situations, a generative AI model can be released by AI model providers having self-determined the most useful tasks that can be supported by the generative AI model. Upon release of the generative AI model, users may not value the same tasks that the AI model providers believe are the most useful, which can cause a disconnect between initial prioritization of tasks and the potential tasks that can be found useful in practice. As a result, generative AI models that do not comply with implementation requirements may be released, leading to wasted memory and processing resources consumed by distribution and execution of such generative AI models.

Aspects of the present disclosure address the above and other deficiencies by providing a generative artificial intelligence (AI) task-based performance assessment system that may be used to automatically analyze the performance metrics of each task by the generative AI model, compare the quality of performance of each task against existing generative AI models, predict user task performance valuations for each task, and create generative AI model task metrics that enable efficient task prioritization for the generative AI model. Performance metrics may be statistical or numerical values that, on a scale or compared to a threshold, indicate a task performance based on performance data. In some embodiments, the generative AI task-based performance assessment system may utilize several core characteristics to evaluate task-based performance metrics of the AI model, including, for example, user demand for each AI model task, average number of required prompts for a single satisfactory answer, comparative performance of the AI model against other generative AI models for each task, etc. In some embodiments, the scope of the core characteristics can be limited by a number of factors such as geographic regions, user statistics such as age and gender, and the like.

In some embodiments, prior to implementation of the generative AI model, the generative AI task-based performance assessment system can determine performance metrics of each task by the generative AI model. To generate these performance metrics, the generative AI task-based performance assessment system may determine a user demand for each task. In some embodiments, the user demand for each task can be identified through analytics and the like and can be collected specifically for the generative AI task-based performance assessment system. In some embodiments, the user demand for all tasks can be collected from external sources, for example, online published sources that are identified and collected by the generative AI task-based performance assessment system. In some embodiments, the user demand can be determined from user demand statistics of other generative AI models. In some embodiments, the user demand for each task may not be from the same source and the generative AI task-based performance assessment system may collect the user demand statistics from multiple sources to consolidate user demand for each task.

The generative AI task-based performance assessment system may determine a ratio between performance metrics of each task executable by the generative AI model and performance metrics of each task executable by existing generative AI models. In some embodiments, a generative AI model may require more than one prompt to generate a satisfactory response. The generative AI task-based performance assessment system may utilize pre-collected data on the average number of prompts required for each task of the existing generative AI models. The generative AI task-based performance assessment system may, using a set of prompts, collect data on the average number of prompts required for each task of the existing generative AI models. For example, for a coding task, the generative AI task-based performance assessment system may have a set of 50 prompts such as, “generate a block of code to print ‘hello world’.” The prompt may include iterative sub-prompts that are usable if the response to the initial prompt was unsatisfactory. For example, a sub-prompt may be, “in C++.” The generative AI task-based performance assessment system may evaluate each response and compare the response to an acceptable response. In some embodiments, the comparison may include, for example, using a large language generator to determine if the same information is provided in both the response and the acceptable response. The comparison may include the number of words in the response compared to the acceptable response. The generative AI task-based performance assessment system may track the number of sub-prompts required to achieve the expected response for each of the 50 prompts. The same 50 prompts may be used by the generative AI task-based performance assessment system on the generative AI model to be released. Comparing a summation of the number of sub-prompts for each prompt of the generative AI model and the existing generative AI models can determine a ratio of task performance metrics for the generative AI model compared to each existing generative AI model. The ratio of task performance metrics can be ranked to identify a sub-set of tasks in which the performance metric of the generative AI model is the highest. In some embodiments, the generative AI task-based performance assessment system may do a zero-shot analysis or a one-shot analysis to determine performance metrics of the tasks of generative AI models.

The ratios determined by the generative AI task-based performance assessment system may also be used to determine tasks that are underperforming (e.g., have lower performance metrics) compared to existing generative AI models. For example, a ratio of performance metrics of a task may indicate that the generative AI model requires 5 more prompts to provide a sufficient email compared to one or more existing generative AI models. The generative AI task-based performance assessment system may utilize a threshold to determine whether the ratio of performance metrics indicates a comparatively poor performing task. Using the user demand, ratios, the identified performance metrics of each task by the generative AI model, the generative AI task-based performance assessment system may determine a ranking of each task of the generative AI model prior to distribution of the generative AI model.

In some embodiments, after distribution of the generative AI model, the generative AI task-based performance assessment system may reevaluate the performance metrics using the core characteristics periodically. For example, reevaluation can occur on a set schedule such as once a month. In some embodiments, the user demand for one or more tasks may be monitored and, once the user demands have changed by a threshold amount, the generative AI task-based performance assessment system can reevaluate the performance metrics of the generative AI model. In some embodiments, the generative AI task-based performance assessment system may monitor other known generative AI models or online sources to identify the distribution of a generative AI model. The reevaluation may include generating comparative ratios against the new generative AI model.

In some embodiments, the performance metrics of each task by the generative AI model can be utilized to determine pricing for the generative AI model. The generative AI task-based performance assessment system may determine a price-performance ratio using at least the average number of required prompts for a single satisfactory answer and the performance metrics of the competing generative AI models for each task as determined during the task-based performance evaluation of the generative AI model. A price-performance ratio can be a ratio that identifies a price, for example cost per token, for the generative AI model based on the ratios. A token may be a discrete unit of text such as a word or sub-word supplied to, or generated by, the generative AI model. If the performance metrics of the generative AI model for a task are higher (e.g., by a threshold difference such as a percentage or ratio) than the performance metrics of the existing generative AI models, the pricing may be up to two times higher for that task. In some embodiments, the generative AI task-based performance assessment system may identify a subset of tasks in which the performance metrics of the generative AI model are higher or similar to the performance metrics of the existing generative AI models.

In some embodiments, the generative AI task-based performance assessment system may identify a price for all tasks whose performance metrics have been determined by the ranking to be higher or equal to the performance metrics of the existing generative AI models. The generative AI task-based performance assessment system may identify, for each price of a plurality of prices, a revenue for each of the identified tasks. By summing the revenue of each identified task at each price, the generative AI task-based performance assessment system may determine a price in which the total revenue is the highest.

In some embodiments, the generative AI task-based performance assessment system may identify a ranking of the zero-shot or one-shot analysis of all tasks of the generative AI model without a comparative ratio to existing generative AI models. Using the ranking, the generative AI task-based performance assessment system may determine a sub-set of tasks of the generative AI model for which the performance metrics are the highest and determine cost per token based on the sub-set of tasks. For example, if the sub-set of tasks include tasks that generally comprise responses of higher numbers of tokens, the price per token may be lower. For example, a coding task may produce more tokens than an email draft task. A cost per token of 1 cent per 1000 tokens may cost the user more for a coding task than an email draft task. Upon determining that the generative AI model has higher performance metrics on coding tasks, the generative AI task-based performance assessment system may set a lower cost per token than would be set for an email draft task so as not to set a price too high to drive away users. Alternatively, a generative AI model that has higher performance metrics on email drafting tasks may be able to increase the cost per token compared to the generative AI model that has higher performance metrics for the coding tasks.

In some embodiments, the price-performance ratio can be adjusted according to demand. For example, if a task that has the highest performance metric is only utilized by 0.3% of users, the generative AI task-based performance assessment system may not include the task when determining price-performance ratios. In some embodiments, the price-performance ratio can be adjusted according to the market size acquired for a task by the generative AI model. For example, a generative AI model may have a task that constitutes only a 5% demand of the users of the generative AI model, but that task may have 98% of the market for that task. The price-performance ratio may be adjusted because of the command of the market of the generative AI model.

In some embodiments, the generative AI task-based performance assessment system can utilize the evaluation of the performance metrics of each task of the generative AI model to refine the generative AI model. In some embodiments, upon determining a task ratio indicates that the task performed by the generative AI model has a higher performance metric than the task performed by existing generative AI models, the generative AI task-based performance assessment system may increase visibility of the task. For example, the generative AI task-based performance assessment system may identify that the generative AI model has a higher performance metric for email drafting tasks. The generative AI task-based performance assessment system may generate a statement shown on a user interface promoting the email drafting functionality.

In some embodiments, upon determining a task ratio indicates the generative AI model has a performance metric much higher than a performance metric of existing generative AI models, the generative AI task-based performance assessment system may prevent reevaluation of the task. In some embodiments, the generative AI task-based performance assessment system may prevent self-improvement or self-learning for such tasks to save on computational resources.

The present technique utilizes data capture, monitoring, and analysis of generative AI models of the generative AI task-based performance assessment system and external to the generative AI task-based performance assessment system to properly evaluate performance metrics of tasks by a generative AI model that was previously difficult because of the complexity of generative AI model tasks. The generative AI task-based performance assessment system may determine the performance metrics of each task of the generative AI model of the generative AI task-based performance assessment system. After determining the performance metrics, the generative AI task-based performance assessment system can utilize a ranked task list of the generative AI models to generate recommendations related to future use of the generative AI models (e.g., recommendations for intelligently or competitively pricing the models for optimizing revenue, recommendations for improved visibility of the models, etc.). As a result, generative AI models that comply with implementation requirements are released, leading to efficient use of memory and processing resources consumed by distribution and execution of such generative AI models.

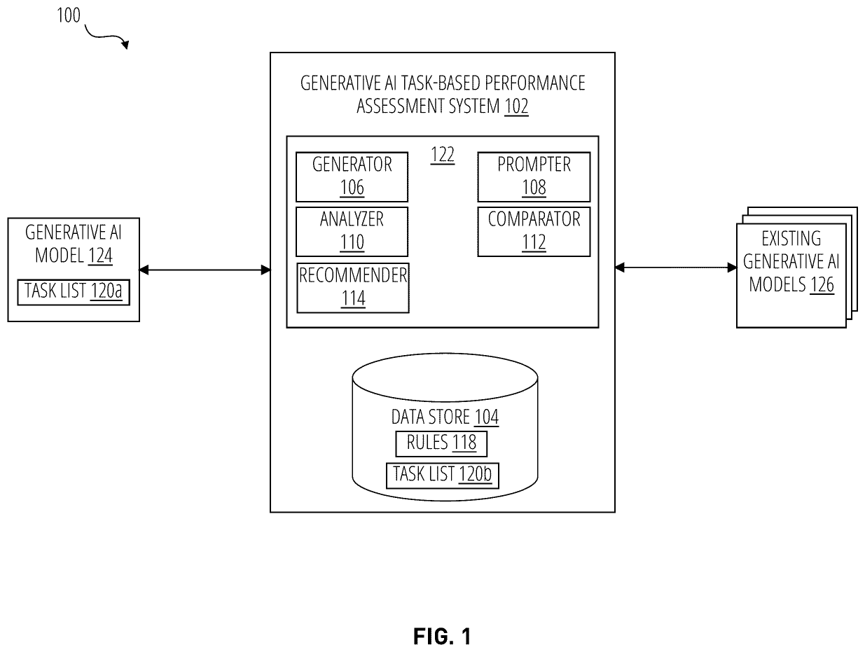

FIG. 1 is a schematic block diagram 100 of an example generative AI task-based performance assessment system 102 architecture for analyzing the performance metrics of each task performed by the generative AI model 124, according to at least one embodiment. The generative AI task-based performance assessment system 102 may include, or may be in data communication with, a generative AI model 124 and one or more existing generative AI models 126. The generative AI model 124 may be a machine learning model capable of generating new content by performing tasks. Task may include, for example, generating text, images, music, and/or videos based on a set of training data. In some embodiments, the generative AI model 124 may be capable of performing one or more tasks. The tasks may be related such that they generate a same type of content. For example, the generative AI model 124 may generate text when performing tasks such as drafting a story, composing an email, generating code, and the like.

The generative AI model 124 may perform a task to generate content based on a prompt. In some embodiments, the generative AI model 124 may maintain a task list 120a for the generative AI model 124. Upon receiving a prompt that would require performance of a task not included in the task list 120a, for example to generate an image when image generation is not a task the generative AI model 124 is configured to perform, the generative AI model 124 may return a negative response without attempting to perform the task. The generative AI model 124 may be connected to the generative AI task-based performance assessment system 102 such that the generative AI model 124 can be controlled, prompted, modified, updated, and/or retrained by the generative AI task-based performance assessment system 102.

The one or more existing generative AI models 126 may be models that exist external to the generative AI task-based performance assessment system 102 such that the generative AI task-based performance assessment system 102 can interact with the existing generative AI models 126 by, for example, prompting the existing generative AI models 126 and receiving a response, but cannot modify or control them in any way.

The generative AI task-based performance assessment system 102 can include a central processing unit and/or memory 122 capable of executing one or more programs to analyze the performance metrics of generative AI tasks of the generative AI model 124 and the existing generative AI models 126. In some embodiments, a single program may be useable to analyze the performance metrics. In some embodiments, the performance metrics may be analyzed using multiple programs, segmented according to the actions required for completing the analysis.

The generative AI task-based performance assessment system 102 may include a generator 106 for generating input options to be used to prompt a generative AI model. An input option may be a text input that can be used to evaluate the performance metrics of a task by an AI model. The input option may identify a task to be completed and a subject matter for the task. For example, an input option could be “draft an email to congratulate a colleague on a promotion.” The task identified in the input option would be ‘drafting an email’ and the subject would be to ‘congratulate a colleague on a promotion.’ The generator 106 may be used to generate a set of input options for any one task. For example, the generator 106 may generate 100 input options for a task to draft an email, 100 input options for a task to generate a resume, 100 input options for a task to generate a block of code, etc. In some embodiments, the generator 106 may generate input options for every task the generative AI model 124 is configured to perform. The generator 106 may utilize the task list 120b stored within a data store 104 of the generative AI task-based performance assessment system 102. The task list 120b may be updated according to the task list 120a of the generative AI model 124.

In some embodiments, the input options may include a prompt and one or more sub-prompts. For example, a prompt may be an initial input for a generative AI model. After receiving a response to the prompt, the generative AI task-based performance assessment system 102 may determine the response is insufficient and/or additional information may be required. A sub-prompt may be provided to supply additional information to refine the response to a desirable response. For example, a prompt may be “generate a block of code for an unbeatable game of tic-tac-toe.” The response may include code that is in a coding language other than a desired coding language, or may reply with a request for a coding language rather than with a block of code. The sub-prompt may be, for example, “in C.” In some embodiments, a set of one or more sub-prompts and a prompt may be included for each input option. In some embodiments, the sub-prompts may be generated with the prompts prior to the prompts being provided to the generative AI model 124 and the existing generative AI models 126. In some embodiments, the sub-prompts may be generated after a response to the prompt. The sub-prompt may be generated by the generator 106, a secondary generator external to the system, or another LLM model that is trained to prompt the specific generative AI model tasks. In some embodiments, the generator 106 may generate prompts that are intentionally vague to test the ability of the generative AI model 124 and 126 handle ambiguity.

The generative AI task-based performance assessment system 102 may include a prompter 108 which may utilize the input options and/or the sets of input options to prompt the generative AI model 124 and/or the existing generative AI models 126. In some embodiments, the prompter 108 may identify within a graphical user interface of the generative AI model 124 and/or existing generative AI models 126 to identify a prompt input interaction device. The prompter 108 may then input each input option of the input options into the generative AI models. The prompter 108 may, in some embodiments, collect the response to the input option and provide it to the generative AI task-based performance assessment system 102, for example at an analyzer 110, for analysis. Depending on the analysis, the prompter 108 may provide one or more sub-prompts of the input option to the generative AI models, or may provide a next prompt of a next input option. In some embodiments, the prompter 108 may prompt the generative AI models 124 and 126 with the same input option multiple times to test repeatability (e.g., the ability of the generative AI models 124 and 126 to produce consistent outputs).

In some embodiments, the generator 106 and/or the prompter 108 may be configured to convert the input options into plain language to be used to prompt the generative AI models. The plain language may intentionally be written in a verity of formats, such as shorthand, full and grammatically correct sentences, incomplete and grammatically incorrect sentences, and the like. The generator 106 and/or the prompter 108 may be configured to provide prompts that would be expected from a human prompting a response from the generative AI models.

The generative AI task-based performance assessment system 102 may include an analyzer 110 that may be configured to receive the responses from the prompter 108. The analyzer 110 may be used to analyze the response to the prompts and/or sub-prompts of the input options to determine the validity of the response. In some embodiments, the analyzer 110 may analyze the response to all prompts and sub-prompts of the input option to identify the number of sub-prompts required for a valid response. For example, the generative AI task-based performance assessment system 102 may determine a one-shot and/or multi-shot scores. In some embodiments, the generator 106 may prepare an expected response for each input option and may provide it to the analyzer 110. The analyzer 110 may compare the generated response to the expected response. In some embodiments, the analyzer 110 may analyze the relevance of the answer to the subject provided in the prompt. In some embodiments, the analyzer 110 may compare the words of the expected response and the generated response. In some embodiments, the analyzer 110 may review the factual accuracy of the output. In some embodiments, the analyzer 110 may review the output to determine the coherence of the response.

In some embodiments, the prompter 108 may prompt the generative AI model 124 using the generated input options. The analyzer 110 may review the output of the generative AI model 124 for each input option to identify sets of input options to use to prompt the existing generative AI models 126. The analyzer 110 may select the sets of input options based on whether the output indicates the input option effectively communicates the desired task, provides sufficient context, and/or produces high-quality, relevant, and/or coherent outputs.

In some embodiments, having determined the sets of input options of the input options to prompt the existing generative AI models 126, the generative AI task-based performance assessment system 102, for example at the prompter 108, may prompt the existing generative AI models 126 as described above. The analyzer 110 may be used with the prompter 108 to prompt the existing generative AI models 126 with sub-prompts from the input options, as necessary. After determining all input options of the sets of input options have been completed, the analyzer 110 may provide the responses of both the generative AI model 124 and the existing generative AI models 126 to the comparator 112. The comparator 112 can compare the performance metrics of the generative AI model 124 and the existing generative AI models 126 for each task on the task lists 120b.

In some embodiments, the comparator 112 may utilize a set of one or more rules 118 stored in the data store 104 of the generative AI task-based performance assessment system 102. The rules 118 can be utilized to determine a ranking for the performance metrics of the tasks of the generative AI model 124 using the comparison to the performance metrics of the tasks by the existing generative AI models 126. For example, a rule of the rules 118 can include methods for scoring the outputs for each input option and generating a ratio of relative performance metrics of the task between the generative AI model 124 and the existing generative AI models 126. In some embodiments, generating a ranking can include considering alternative data.

The comparator 112 may utilize user demand data for the generative AI model 124 and/or the existing generative AI models 126. User demand data may include a percentage of user demand for any one task performed by the generative AI model 124. For example, the generative AI model 124 may draft emails, prepare resumes, and generate code blocks. User demand for drafting emails may account for 34% of the demand for the generative AI model 124. The comparator 112 may use this demand to rank email drafting compared to resume preparation and code block generation. In some embodiments, user demand may be a percentage of market share that is used by a task the generative AI model 124. For example, the generative AI model 124 may have 6% of the market share for users drafting emails using generative AI models and one of the existing generative AI models 126 may have 4% of the market share for users drafting emails using generative AI models. When determining the rankings, the comparator 112 may uses the comparison of market share of user demand for the task.

After determining a ranking according to the rules 118, the comparator 112 may provide the ranking and other computational data used in creating the ranking to a recommender 114. The recommender 114, in some embodiments, may analyze the ranking and/or the computational data to generate recommendations for improving and/or focusing the operations of the generative AI model 124. In some embodiments, the recommender 114 may assign a price for one or more aspects of the generative AI model 124. In some embodiments, the recommender 114 can identify tasks with lower performance metrics such that the generative AI model 124 would benefit from refraining from devoting resources to the tasks in the future. In some embodiments, the recommender 114 can identify tasks with higher performance metrics and/or may not be experiencing proportional user demand based on performance metrics of the task. The recommender 114 may cause prompts to users to be focused on promoting the tasks.

In some embodiments, the recommender 114 may generate recommendations and provide the recommendations to the generative AI model 124 or another source for implementation. In some embodiments, the recommender 114 may generate suggestions based on the recommendations to be provided to an administrator of the generative AI model 124. In some embodiments, the recommender 114 may may direct adjustments for the generative AI model 124.

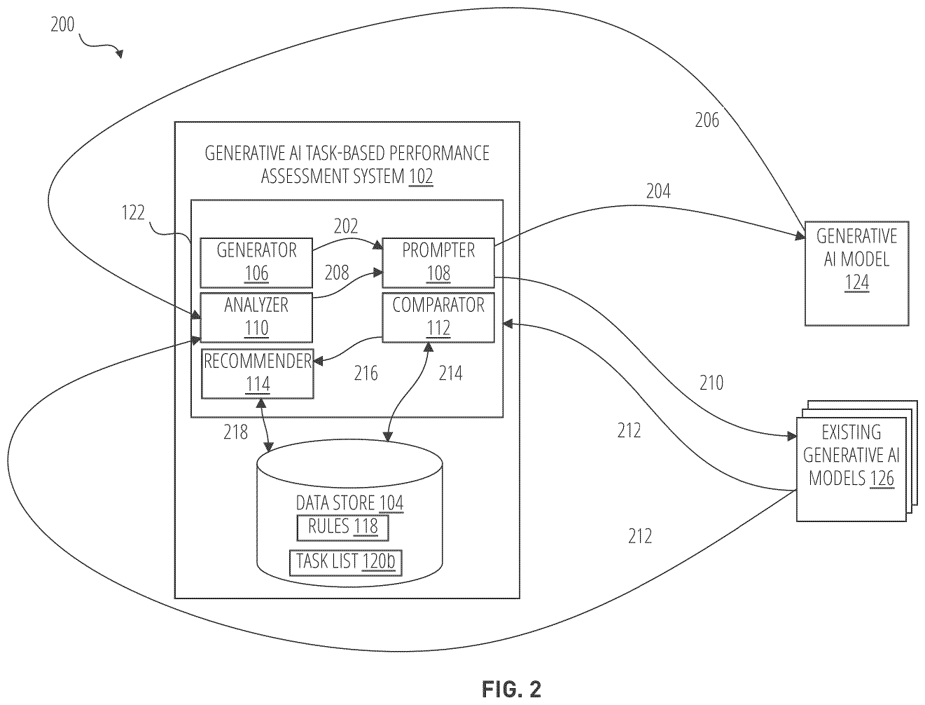

FIG. 2 is a flow diagram 200 for reviewing and analyzing the performance metrics of each task of the generative AI model 124 using the generative AI task-based performance assessment system 102 of FIG. 1, according to at least one embodiment. As described above, the generative AI task-based performance assessment system 102 may include a central processing unit 122 that can be used to execute instructions to complete various actions of the generative AI task-based performance assessment system 102. The instructions may be separated into separate components that complete individual tasks or may be a single component running on the central processing unit 122.

In some embodiments, the generator 106 of the generative AI task-based performance assessment system 102 may generate input options. As described above, the input options may be prompts that, when provided to generative AI models, may prompt an output. An input option may include a prompt that is initially provided to the generative AI model and one or more sub-prompts that may be used to re-prompt the generative AI model to improve the output of the generative AI model. In some embodiments, the generator 106 will generate the input options according to the task list 120a, such that each task within the task list 120b is targeted by at least one input option.

The generator 106 may provide 202 the prompts to a prompter 108. The prompter 108 may, one input option at a time, provide 204 a prompt of the input option to the generative AI model 124. A prompt may require the prompter 108 to generate plain language, for example using a large language model or other language generator, to supply the generative AI model 124 with a prompt. The prompt may mimic human prompts to test the generative AI model 124 response.

In some embodiments, the generator 106 will generate a set number of input options that exceeds an intended number of input options to be provided to existing generative AI models 126. The set number of input options may be a pre-determined number that may be filtered down by the analyzer 110. To adequately evaluate performance metrics of a task by one or more of the existing generative AI models 126, the generative AI task-based performance assessment system 102 may need to prompt the existing generative AI models 126 with the intended number of input options. For example, one input option may not give an indication of performance metrics of the task in general, but rather the performance metrics of the existing generative AI models 126 for that prompt. An excessive number of input options may not provide any additional information on the performance metrics of the task but may take excessive amounts of time to generate outputs for all of the input options and review the outputs. The intended number of input options may be a pre-determined number that is optimized to provide enough outputs to indicate the performance metrics of the task without generating unnecessary and burdensome data.

The input options, for example the set number of input options, may be used by the prompter 108 as inputs that are provided 204 to the generative AI model 124. The input options may be provided one at a time such that a prompt as part of the input option may generate an output that is evaluated prior to a second input option being used to prompt the generative AI model 124. Should the output indicate that a sub-prompt is required, the sub-prompt may be provided prior to moving to the next input option.

The generative AI task-based performance assessment system 102 may receive 206 the output of the generative AI model 124 at the analyzer 110. The analyzer 110 may analyze the output of the generative AI model 124 as described above to determine if the prompt has been adequately responded to, or if a sub-prompt of the input option should be provided 204 to the generative AI model 124.

Upon determining an action for the prompter 108, the analyzer 110 may provide instructions 208 to the prompter 108. The instructions may be to prompt the generative AI model 124 with a sub-prompt, or a progress to a new input option. In some embodiments, the prompter 108 may, in response to determining that all input options have been input into the generative AI model 124, reply to the instructions 208 to inform the analyzer 110 of the completion of the set of input prompts. In some embodiments, the analyzer 110 may review the input options and outputs of the generative AI model 124 and may select a set of input options to provide to the prompter 108.

In some embodiments, the prompter 108 may use the set of input options as inputs to the existing generative AI models 126. The generative AI task-based performance assessment system 102 may receive 212 the outputs from the existing generative AI models 126 at the analyzer 110 and/or the comparator 112. In some embodiments, the analyzer 110 may analyze the outputs from the existing generative AI models 126 to determine the adequacy of the answer and instruct the prompter 108 to prompt the existing generative AI models 126 with a sub-prompt or the next input option.

In some embodiments, the comparator 112 may receive 212 the output from both the generative AI model 124 and the existing generative AI models 126. The comparator 112 may compare the outputs from the generative AI model 124 and existing generative AI models 126 for each input option to determine the task performance metrics between the AI models for each task.

In some embodiments, the comparator 112 may communicate with 214 the data store to utilize the rules 118 stored in the data store 104 to generate a ranking of the performance metrics of the tasks of the generative AI model 124. In some embodiments, the comparator 112 may update the task list 120b ordering based on the evaluation from the comparator. The comparator 112 may provide 216 the results of the comparison to the recommender 114.

In some embodiments, the recommender 114 may generate recommendations for the generative AI model 124. In some embodiments, the recommender 114 communicate 218 with the data store 104. In some embodiments, the recommender 114 may edit the task list 120a and the corresponding task list 120b within the data store to limit the tasks supported by the generative AI model 124. In some embodiments, the recommender 114 may generate tips to the user to be displayed on a graphical user interface to encourage more users to utilize the highest performing tasks of the generative AI model 124. In some embodiments, the recommender 114 may recommend, or cause implementation of, a price for the generative AI model 124.

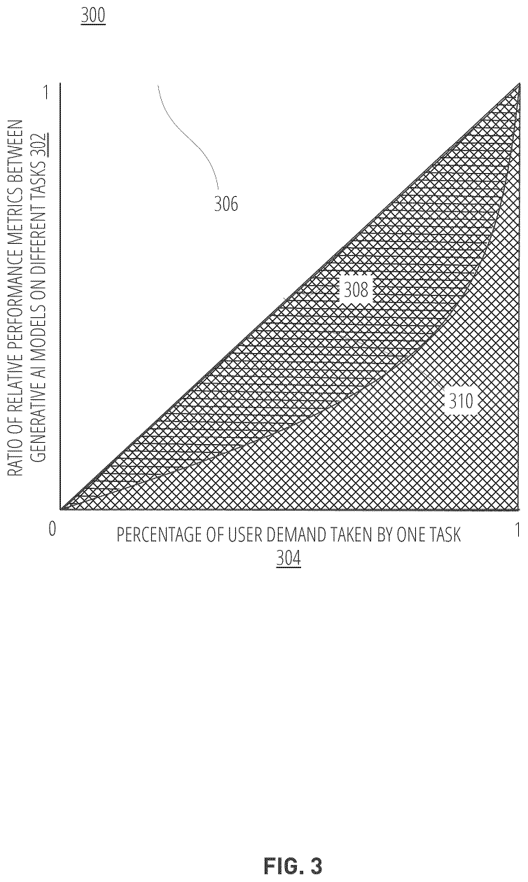

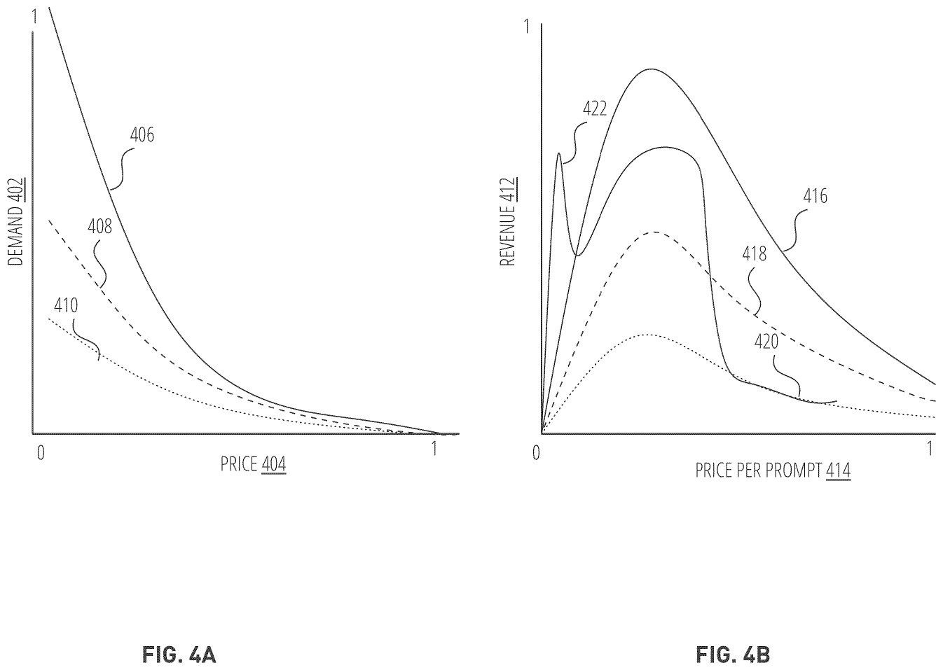

FIG. 3 illustrates an example graph 300 for relative performance metrics between generative AI models on different tasks 302 and user demand taken by one task 304, according to at least one embodiment. In some embodiments, the ratio of relative performance metrics between generative AI models on different tasks 302 can be generated at the comparator 112. The ratio may include the performance metric of a task at the generative AI model 124 determined using the set of input options and performance metrics of the task of one or more of the existing generative AI models 126. In some embodiments, the ratio may be a numeric evaluation of the language of the output in response to the input options. In some embodiments, the numeric evaluation can be generated by leveraging natural language processing and machine learning techniques to assess factors such as clarity, relevance, coherence, and completeness. In some embodiments, the comparator 112 may use large language models fine-tuned for evaluation tasks, to interpret and score human-written text. Metrics may be employed to compare responses against ideal answers, while newer approaches incorporate semantic similarity and contextual understanding to judge quality more holistically. Additionally, AI-based rubric systems or custom classifiers can be trained to align with human evaluation standards. In some embodiments, the graph 300 may be generated using logic as described in FIG. 4B below.

In some embodiments, the numeric value representing the performance metric of the task by the generative AI model 124 and the one or more existing generative AI models 126 may be adjusted by, weighted by, or the like, the sub-prompts. For example, the increase in score between a prompt and a first sub-prompt may be weighted more heavily than an increase in score between the first sub-prompt and the second sub-prompt. In some embodiments, the number of sub-prompts required to come to an adequate output may be used to weight the numeric score for the performance metric of the AI models for a task. In some embodiments, a ratio may be created such that a lower ratio indicates a greater performance advantage of the task of the generative AI model 124 over the one or more existing generative AI models 126.

In some embodiments, the percentage of user demand taken by one task 304 may be a percentage of user demand of one task compared to the other tasks of the generative AI model 124. In some embodiments, the percentage of user demand taken by one task 304 may be a percentage of user demand of one task of the generative AI model 124 compared to user demand of the existing generative AI models 126 (e.g., market share, frequency of use by a user, hits per period). In some embodiments, percentage of user demand taken by one task 304 may be identified by the generative AI task-based performance assessment system 102 by querying usage statistics of the AI models or identifying statistics gathered and published in a public forum, such as by a website, academic paper, or the like.

The graph 300 may include a first section 306 that occurs when there is a low user demand 304 for the task and an equal or low comparison ratio of relative performance metrics between generative AI models on different tasks 302. In some embodiments, tasks that are determined by the comparator 112 and/or the recommender 114 to fall within the first section 306 may be tasks performed by the generative AI model 124 that will generate no revenue for the generative AI model 124. Such tasks identified within the first section 306 may be tasks that are less beneficial for the generative AI model 124.

In some embodiments, generative AI model 124 resources that were previously devoted tasks that fall within the first section 306 may be reallocated to alternative tasks. In some embodiments, the resources may include large datasets for training, pre-trained model weights, computational infrastructure like GPUs or TPUs, and supporting software frameworks. The recommender 114 may recommend that retraining be halted, computational infrastructure be diverted from supporting the task, and the like. In some embodiments, the recommender 114 may not include tasks that fall within the first section 306 when determining a price per token for the generative AI model 124.

The graph 300 may include a second section 308 that occurs when there is a medium amount of user demand 304 for the task and a medium comparison ratio of relative performance metrics between generative AI models on different tasks 302. In some embodiments, tasks that are determined by the comparator 112 and/or the recommender 114 fall within the second section 308 may be tasks performed by the generative AI model 124 that will generate some revenue for the generative AI model 124. Such tasks identified as tasks within the second section 308 may be tasks that the generative AI model 124 may be competitive with the existing generative AI models 126, current or future.

In some embodiments, generative AI model 124 recommender 114 may utilize the tasks within the second section 308 to determine a price per token for the generative AI model 124. In some embodiments, the revenue generated by tasks within the second section 308 may be adjustable by slight increases to performance metrics and/or user demand. The recommender 114 may recommender 114 or cause implementation of efforts, such as messages to the user promoting the tasks within the second section 308.

The graph 300 may include a third section 310 that occurs when there is a high user demand 304 for the task and a high of performance metric discrepancy between generative AI models on different tasks 302. In some embodiments, tasks that are determined by the comparator 112 and/or the recommender 114 to fall within the third section 310 may be tasks performed by the generative AI model 124 that will generate revenue for the generative AI model 124 so long as the performance metric is greater than or equal to the performance metric of the task by the existing generative AI models 126. Such tasks identified as tasks that are the most beneficial for the generative AI model 124.

In some embodiments, generative AI model 124 resources that were previously devoted to tasks that fall within the first section 306 may be reallocated to tasks within the third section 210. In some embodiments, the resources may include resources storing large datasets for training, pre-trained model weights, computational infrastructure like GPUs or TPUs, and supporting software frameworks. The recommender 114 may recommend that retraining occur more frequently, computational infrastructure be allocated to supporting the task, and the like. In some embodiments, the recommender 114 may include tasks that fall within the third section 310 when determining a price per token for the generative AI model 124.

FIG. 4A illustrates an example graph 400 for demand 402 based on price per prompt price 404 for tasks executed using the generative AI model, according to at least one embodiment. The graph 400 represents an analysis that can be made by the recommender 114 to determine a price for the generative AI model 124. The graph 400 includes the demand 402 compared to the price 404 for a first task first task 406, a second task second task 408, and a third task third task 410. As the price 404 increases, the demand 402 decreases for the first task 406, second task 408, and third task 410. As depicted, the demand 402 for the first task 406 may be higher than the second task 408. The demand 402 for the first task 406 and the second task 408 may be higher than the demand 402 for the third task 410. As indicated by the graph 400, a higher demand 402, such as for the first task 406, may allow for demand 402 to remain higher than zero for more prices 404.

FIG. 4B an example graph 424 for revenue 412 based on price per prompt 414 for tasks with demands 402 as depicted in graph 400, according to at least one embodiment. In some embodiments, the price 404 can be price per token generated or input, price per prompt, and/or price per response. Based on the price setting metric, the recommender 114 may utilize analysis of the number of tokens required for an adequate response as described above, the number of sub-prompts of an input option required for an adequate response, and the like. The first revenue curve first revenue curve 416 indicates the revenue of the first task 406 at a given price. The second revenue curve 418 indicates the revenue of the second task 408 at a given price. The third revenue curve 420 indicates the revenue of the third task 410 at a given price. The total revenue curve 422 can be a summation of the revenue of all tasks performable by the generative AI model 124. The total revenue curve 422 can be generated by ranking the tasks in order of the ratio of relative performance metrics between generative AI models on different tasks 302 and may select a subset which generates the most revenue. For example, the graph 424 depicts three tasks, however, a higher revenue at the same price may be possible for the top four ranked tasks. Evaluation of a sub-set of the ranked tasks may allow the generative AI task-based performance assessment system 102 to determine a price and a sub-set of tasks to allocate resources to.

In some embodiments, a price to maximize revenue for the generative AI model 124 may be identified prior to existing generative AI models 126 being released, in comparison to active existing generative AI models 126, or a combination of both. In some embodiments, the generative AI task-based performance assessment system 102 can identify and/or set the price using one or more logical expressions. The logical expressions can be used by the generative AI task-based performance assessment system 102 to generate recommendations, for example using the recommender 114 for managing the generative AI model 124.

The total revenue for the generative AI model 124 can be predicted and a price may be selected using different methods. A first method may include prioritizing a sub-set of tasks that are identified, for example by the comparator 112. The comparator 112 and/or the recommender 114 may use the following logic to price the generative AI model 124:

$${max}_{t ∈ [ T - 1 ]} {max}_{q \geq 0} q {\sum }_{s = t + 1}^{T} {D}_{σ ( s )} ( q ) \qquad ( 1 )$$

$${max}_{p} \{ p {\sum }_{s = 1}^{t} {D}_{σ ( s )} ( p ) \vert {κ}_{σ ( t )} \geq \frac{p}{q} \geq {κ}_{σ ( t + 1 )} \} \qquad ( 2 )$$

$$> {max}_{{p}^{′}} \{ p {\sum }_{s = 1}^{{t}^{′}} {D}_{σ ( s )} ( {p}^{′} ) \vert {κ}_{σ {( t )}^{′}} \geq \frac{{p}^{′}}{q} \geq {κ}_{σ ( {t}^{′} + 1 )} \} ∀ {t}^{′} \neq t \qquad ( 3 )$$

Equations 1-3 may be used when assuming that the existing generative AI models 126 that have already been released or are yet to be released will act in accordance with their best interests. In some embodiments, ranking the tasks according to the competitive ratios as discussed above may be executed using equations 1-3. Equation 1 indicates the attempt of the generative AI task-based performance assessment system 102 to find a total revenue of a set of tasks T by analyzing each task t. The maximum revenue can be generated multiplying a price q by a summation of the demand dependent on the price q for each task.

Equation 2 is directed to analyzing the characteristics of the data collected by the generative AI task-based performance assessment system 102 to identify the best revenue the existing generative AI models 126 could generate at the revenue found in Equation 1. Equation 2 includes using a summation of the demand for the existing generative AI models 126 adjusted by the price set at the existing generative AI models 126 to find the total revenue for the existing generative AI models 126. The summation is limited such that the p/q (e.g., a price comparison) is not too high or too low such that the prices are sufficiently close.

Equation 3 is usable to identify a task in which the existing generative AI models 126 has the largest pricing advantage. For every task t′ that is not the task t the existing generative AI models 126 has the most advantage on, the revenue is lower than the revenue for the most competitive task. Equation 3 can be used as a verification to ensure the task of the existing generative AI models 126 that poses the greatest economic threat is identified by the generative AI task-based performance assessment system 102. The generative AI task-based performance assessment system 102 may use the identified task and potential revenue to determine a recommendation for the generative AI model 124. For example, the recommender 114 may determine from the analysis using equations 1-3 that the generative AI model 124 will only benefit if the competitor is incentivized to set higher prices. The recommender 114 may recommend setting a price to encourage the existing generative AI models 126 to set a high price.

In some embodiments, the generative AI task-based performance assessment system 102 may review the prices and compare the performance metrics of the tasks on an interval or other frequency. In some embodiments, having set prices to encourage the increase of prices of existing generative AI models 126, the generative AI task-based performance assessment system 102 may, upon a subsequent evaluation, lower prices to gain revenue.

In one embodiment, equation 4 can be used to check that the revenue from task t, when optimized in isolation, exceeds that of any other task evaluated independently under the same price constraint. This formulation ensures that task t is selected as the strongest position of the existing generative AI models 126 relative to the pricing of the generative AI model 124, enabling task-specific defense strategies and isolation of high-threat competitive zones across a task sequence.

A second method may use the following logic to price the generative AI model 124 to evaluate the potential of a future existing generative AI models 126 outperforming the generative AI model 124 on a task:

$$max ( \text{?} \{ {κ}_{σ ( t )} q {\overline{α}}_{σ ( t )} \text{?} \} , \frac{1}{b} {\overline{α}}_{σ ( {t}^{*} )} {e}^{- 1} ) \qquad ( 4 )$$

$$\text{?} \text{indicates text missing or illegible when filed}$$

Equation 4 may find the revenue for the existing generative AI models 126 or generative AI models yet to be released for future tasks by evaluating the competitors strength on task t (κσ(t)), the price of generative AI model 124 q, a baseline demand potential for the task (α σ(t)), and adjusted by a decay factor that indicates that as the price increases or the competitor increases the performance metrics of the task, the demand drops exponentially. The estimate is bound by an upper theoretical revenue cap for the task based on the demand and pricing sensitivity.

The recommender 114 may utilize Equation 4 to determine pricing recommendations. Further, the recommender 114 may utilize Equation 4 to determine which tasks are best performed comparatively by the generative AI model 124 over present and future existing generative AI models 126. The recommender 114 may then, in some embodiments, recommend prioritizing resource allocation to tasks that are more likely to be resistant to changes in the existing generative AI models 126.

In one embodiment, a revenue estimation framework is disclosed for determining the maximum expected competitor (such as the existing generative AI models 126) revenue across future AI tasks. The logic enables identification of whether any future task presents a higher competitive threat than the known reference, informing proactive pricing or task prioritization strategies.

In one embodiment, equation 4 can be used to check that the revenue from task t, when optimized in isolation, exceeds that of any other task evaluated independently under the same price constraint. This formulation ensures that task t is selected as the strongest position of the existing generative AI models 126 relative to the pricing of the generative AI model 124, enabling task-specific defense strategies and isolation of high-threat competitive zones across a task sequence.

A third method may use the following logic to price the generative AI model 124 to evaluate the potential of a future existing generative AI models 126 outperforming the generative AI model 124 on a task:

$${max {qD}_{2 ( q )}}_{q} \qquad ( 5 )$$

$$( 6 )$$

$$s . t . {max}_{p} \{ {pD}_{1} ( p ) \vert {κ}_{1} q \geq p > {κ}_{2} q \} > {max}_{p} \{ p ( {D}_{1} ( p ) + {D}_{2} ( p ) ) \vert {κ}_{2} q \geq p > 0 \}$$

Equations 5-6 focus on choosing a price q for the generative AI model 124 to maximize the demand based revenue qD2(q). The demand based revenue may be determined under the condition that the best revenue for the present or future existing generative AI models 126 can earn from just one task is greater than the best revenue that could be earned by multiple tasks of the present and future existing generative AI models 126.

In one embodiment, the condition ensures that an existing generative AI models 126, when faced with the selected price q, obtains greater revenue by pricing within a bounded interval—specifically between κ₁qκ1q and κ2qκ2q—and targeting only a partial demand segment D₁(p)D1(p), rather than undercutting to access the entire landscape comprising both D₁(p)D1(p) and D₂(p)D2(p). This structured pricing constraint strategically influences the existing generative AI models' 126 pricing behavior by making competition less profitable, thereby enabling the generative AI task-based performance assessment system 102 to isolate and extract value from the higher-margin segment while limiting competitive pressure for the generative AI model 124.

It should be appreciated that any of the logic can be for currently accessible generative AI models or by anticipating the functionalities of future generative AI models that were not prompted by the generative AI task-based performance assessment system 102.

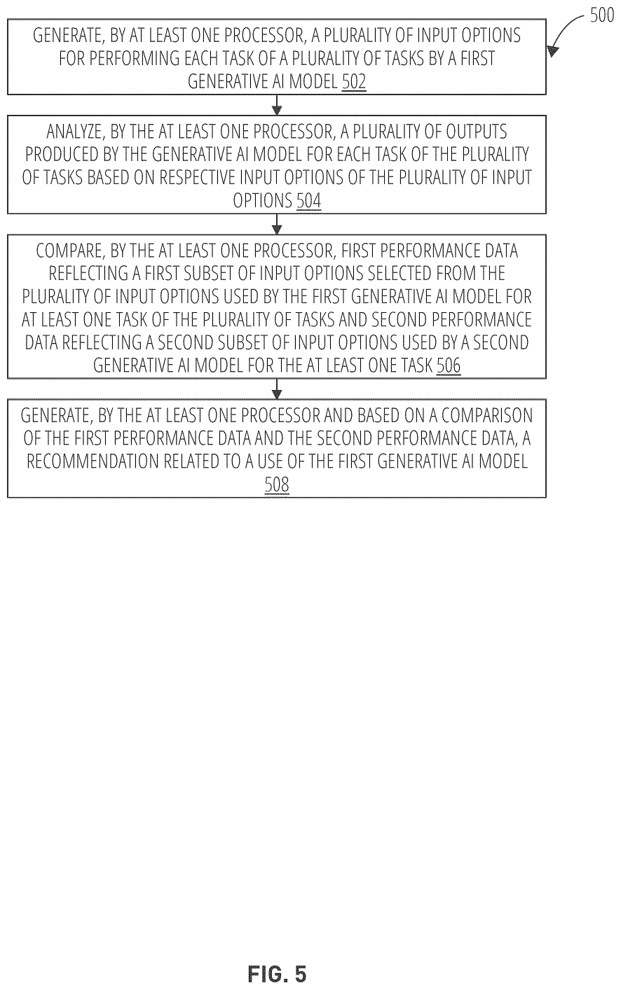

FIG. 5 is a flow diagram of an example method of generative AI task-based performance assessment systems, according to at least one embodiment. In block 502, routine 500 generates, by at least one processor, a plurality of input options for performing each task of a plurality of tasks by a first generative AI model. In some embodiments, the plurality of input options may include one or more prompts code and/or sub-prompts for prompting a response from a generative AI model such as generative AI model 124 and existing generative AI models 126. The input option may be configured to cause task execution of a single task such as “draft an email,” “interpret this equation,” and/or “generate a block of code.” In some embodiments, input options may be generated based on a list received by a system, such as the generative AI task-based performance assessment system 102 from a set of input options or may be generated based on a set of rules for prompting and eliciting outputs from generative AI models by the generative AI task-based performance assessment system 102.

In block 504, routine 500 analyzes, by the at least one processor, a plurality of outputs produced by the generative AI model 124 for each task of the plurality of tasks based on respective input options of the plurality of input options. As described above, analyzing may include reviewing the response to the prompts and/or sub-prompts of the input options to determine the validity of the response. Analysis may include, for example, a one-shot and/or multi-shot score. In some embodiments, response may be compared to a generated response to determine adequacy. In some embodiments, the analysis may include analyzing the relevance of the answer to the subject provided in the prompt. In some embodiments, the analysis may include comparing the words of the expected response and the generated response. In some embodiments, the analysis may include reviewing the factual accuracy of the output. In some embodiments, the analysis may include reviewing the output to determine the coherence of the response. The analysis may result in a first performance data or a set of performance data. Performance data may include the shot scores or a scored metric based on another analysis.

In block 506, routine 500 compares, by the at least one processor, the first performance data reflecting a first subset of input options selected from the plurality of input options used by the first generative AI model for at least one task of the plurality of tasks and second performance data reflecting a second subset of input options used by a second generative AI model for the at least one task. In some embodiments, the first subset of input options corresponds to the second subset of input options. For example, a first subset of input options may be prompts and a second subset of input options may be sub-prompts associated with an input option.

In some embodiments, the first performance data is user demand data for the at least one task, a first average number of sub-inputs for each input option of the first subset of input options for the at least one task, and a first output accuracy metric for each input option of the first subset of input options for the at least one task. In some embodiments, the user demand data may be identified by the generative AI task-based performance assessment system 102. In some embodiments, the user demand data may be supplied to the generative AI task-based performance assessment system 102. In some embodiments, the user demand data may be captured from an existing data source, such as an external survey shared online. In some embodiments, the sub-inputs may be the sub-prompts and may further by sub-prompts of the second subset of input options. In some embodiments, the second performance data is user demand data for the at least one task, a second average number of sub-inputs for each input option of the second subset of input options for the at least one task, and a second output accuracy metric for each input option of the second subset of input options for the at least one task. In some embodiments the second performance data may be collected by prompting the existing generative AI models 126 with the prompts of the first set of input options.

In block 508, routine 500 generates, by the at least one processor and based on a comparison of the first performance data and the second performance data, a recommendation related to a use of the first generative AI model. In some embodiments, the recommendation related to the use of the first generative AI model includes removing the at least one task of the first generative AI model, preventing computing resources from being assigned to self-improvement of the at least one task, or setting a price per token for the plurality of tasks.

In some embodiments, comparing the first performance data reflecting the first subset of input options selected from the plurality of input options used by the first generative AI model for the at least one task of the plurality of tasks and the second performance data reflecting the second subset of input options used by the second generative AI model for the at least one task further comprises determining the first performance data for each of the first task of the first generative AI model and second task of the first generative AI model and the second performance data for the first task of the second generative AI model and the second task of the second generative AI model. In some embodiments, based on the first performance data and the second performance data, ranking the first task and the second task of the first generative AI model. As described above, the ranking may be done using one or more equation of the equations 1-6. In some embodiments, ranking may be done by comparing raw data values of performance value of the first task to the second task to compare the tasks of the generative AI model 124. In some embodiments, the first task of the generative AI model 124 can be compared to the first task of the existing generative AI models 126 or future generative AI models to determine a comparative ratio of the performances of the tasks, as described above.

In some embodiments, the recommendation comprises one or more operations to be performed with respect to the first generative AI model, the method further comprising causing the one or more operations of the recommendation to be performed with respect to the first generative AI model. In some embodiments, the operations may be performed by the generative AI task-based performance assessment system 102 to update the generative AI model 124 according to the rankings. In some embodiments, an operation may be performed to execute a recommendation such as reallocating resources for training and the like, promoting certain tasks on a graphical user interface of the generative AI model 124, and pricing the generative AI model 124.

### Inference and Training Logic

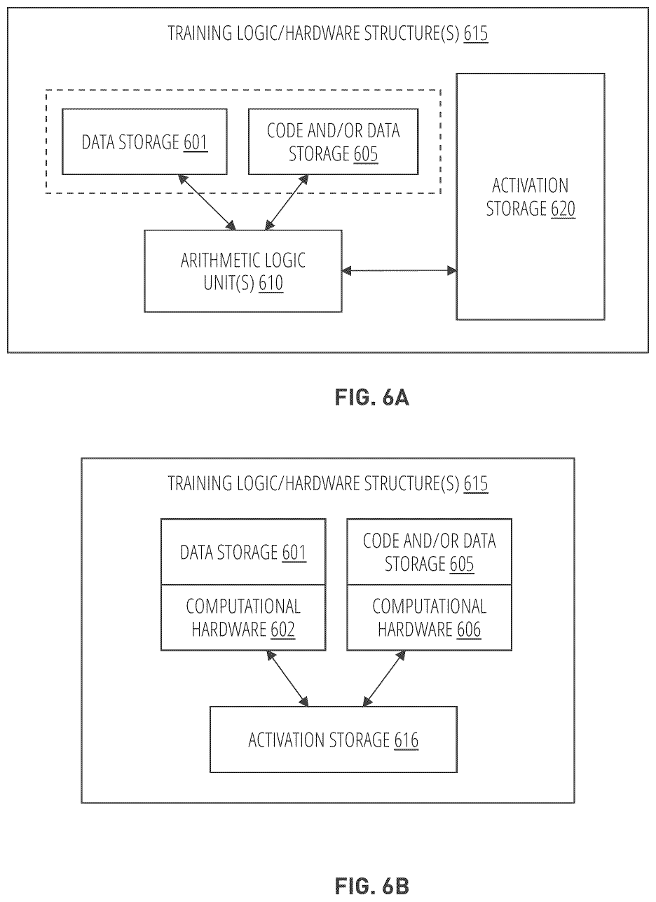

FIG. 6A illustrates inference and/or training logic/hardware structure(s) 615 used to perform inferencing and/or training operations associated with one or more embodiments.

In at least one embodiment, inference and/or training logic 615 may include, without limitation, code and/or data storage 601 to store forward and/or output weight and/or input/output data, and/or other parameters to configure neurons or layers of a neural network trained and/or used for inferencing in aspects of one or more embodiments. In at least one embodiment, training logic 615 may include, or be coupled to code and/or data storage 601 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code, and/or data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 601 may be included with other on-chip or off-chip data storage, including a processor's L1, L2, or L3 cache or system memory.

In at least one embodiment, any portion of code and/or data storage 601 may be internal or external to one or more processors or other hardware logic devices or circuits. In at least one embodiment, code and/or code and/or data storage 601 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 601 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference, and/or training logic 615 may include, without limitation, a code, and/or data storage 605 to store backward and/or output weight and/or input/output data corresponding to neurons or layers of a neural network trained and/or used for inferencing in aspects of one or more embodiments. In at least one embodiment, code, and/or data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 615 may include, or be coupled to code and/or data storage 605 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 605 may be included with other on-chip or off-chip data storage, including a processor's L1, L2, or L3 cache or system memory. In at least one embodiment, any portion of code and/or data storage 605 may be internal or external to one or more processors or other hardware logic devices or circuits. In at least one embodiment, code, and/or data storage 605 may be cache memory, DRAM, SRAM, non-volatile memory (e.g., flash memory), or other storage. In at least one embodiment, a choice of whether code and/or data storage 605 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code, and/or data storage 601 and code and/or data storage 605 may be separate storage structures. In at least one embodiment, code, and/or data storage 601 and code and/or data storage 605 may be a combined storage structure. In at least one embodiment, code, and/or data storage 601 and code and/or data storage 605 may be partially combined and partially separate. In at least one embodiment, any portion of code and/or data storage 601 and code and/or data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 602 that are functions of input/output and/or weight parameter data stored in code and/or data storage 601 and/or code and/or data storage 605. In at least one embodiment, activations stored in activation storage 602 are generated according to linear algebraic and or matrix-based mathematics performed by ALU(s) 610 in response to performing instructions or other code, wherein weight values stored in code and/or data storage 605 and/or data storage 601 are used as operands along with other values, such as bias values, gradient information, momentum values, or other parameters or hyperparameters, any or all of which may be stored in code and/or data storage 605 or code and/or data storage 601 or another storage on or off-chip.

In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALU(s) 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 601, code and/or data storage 605, and activation storage 602 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 602 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement, and/or other logical circuits.

In at least one embodiment, activation storage 602 may be cache memory, DRAM, SRAM, non-volatile memory (e.g., flash memory), or other storage. In at least one embodiment, activation storage 602 may be completely or partially within or external to one or more processors or other logical circuits. In at least one embodiment, a choice of whether activation storage 602 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

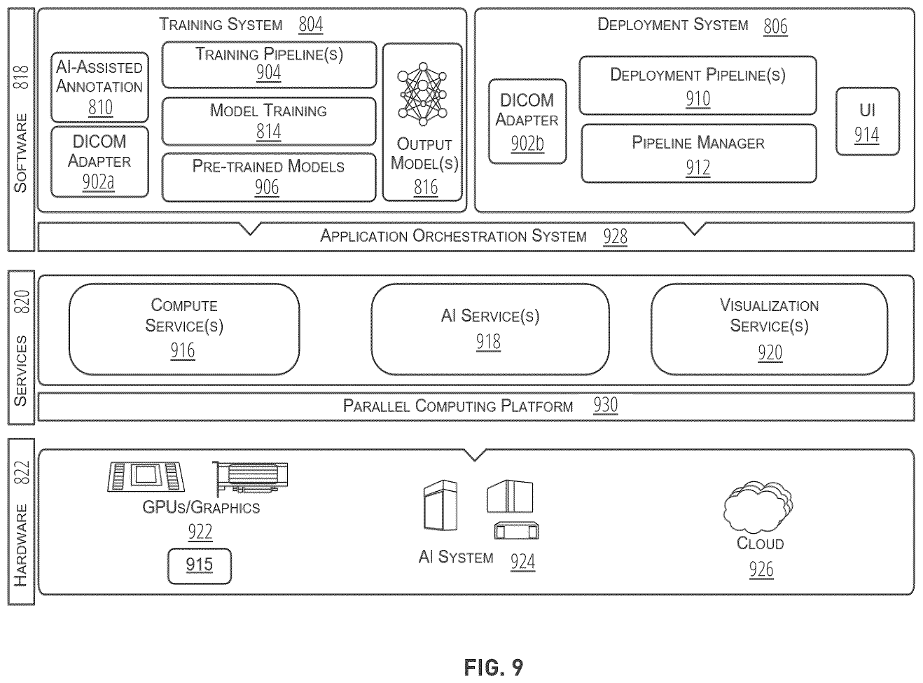

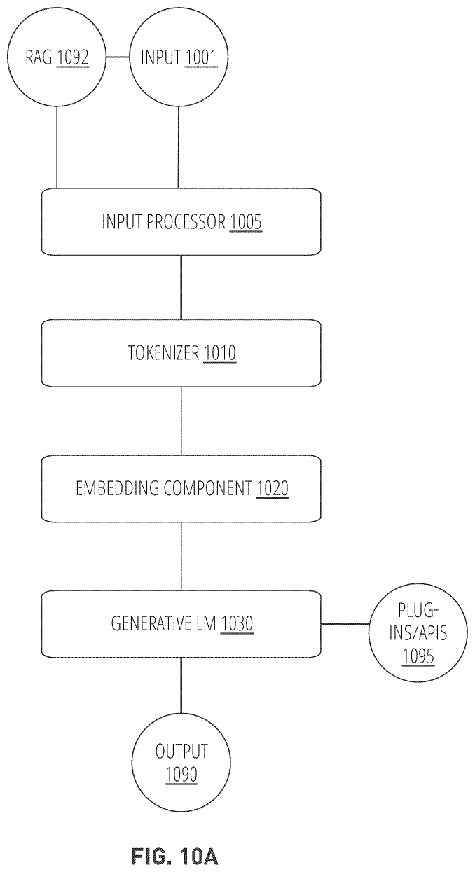

In at least one embodiment, inference and/or training logic 615 illustrated in FIG. 9A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference, and/or training logic 615 illustrated in FIG. 9A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference, and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference, and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, code and/or data storage 601 and code and/or data storage 605, which may be used to store code (e.g., graph code), weight values and/or other information, including bias values, gradient information, momentum values, and/or other parameter or hyperparameter information. In at least one embodiment illustrated in FIG. 6B, each of code and/or data storage 601 and code and/or data storage 605 is associated with a dedicated computational resource, such as computational hardware 615 and computational hardware 620, respectively. In at least one embodiment, each of computational hardware 615 and computational hardware 620 comprises one or more ALUs that perform mathematical functions, such as linear algebraic functions, only on information stored in code and/or data storage 601 and code and/or data storage 605, respectively, result of which is stored in activation storage 602.

In at least one embodiment, each of code and/or data storage 601 and 605 and corresponding computational hardware 615 and 620, respectively, correspond to different layers of a neural network, such that resulting activation from one storage/computational pair 601/615 of code and/or data storage 601 and computational hardware 615 is provided as an input to a next storage/computational pair 605/620 of code and/or data storage 605 and computational hardware 620, in order to mirror a conceptual organization of a neural network. In at least one embodiment, each of storage/computational pairs 601/615 and 605/620 may correspond to more than one neural network layer. In at least one embodiment, additional storage/computation pairs (not shown) subsequent to or in parallel with storage/computation pairs 601/615 and 605/620 may be included in inference and/or training logic 615.

### Neural Network Training and Deployment

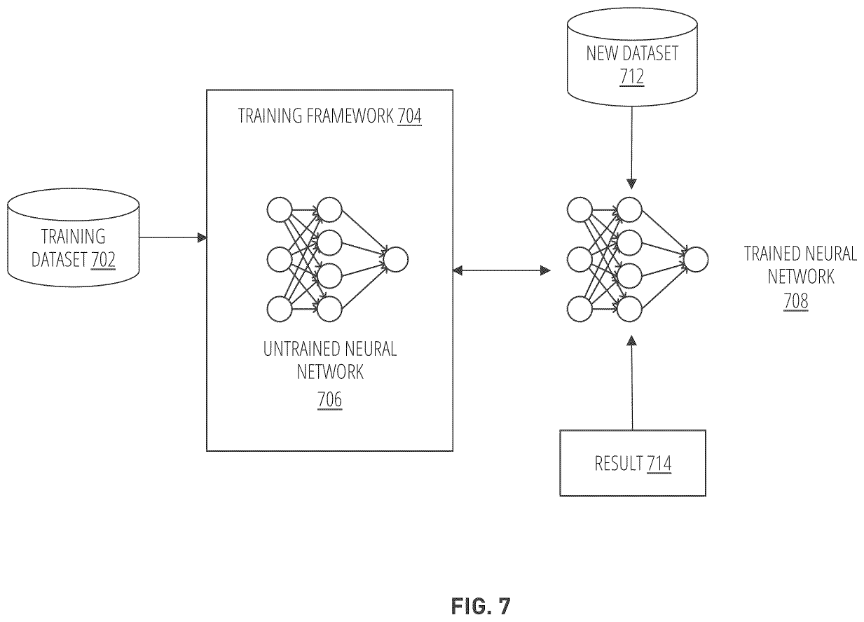

FIG. 7 illustrates training and deployment of a deep neural network, according to at least one embodiment. In at least one embodiment, untrained neural network 706 is trained using a training dataset 702. In at least one embodiment, training framework 704 is a PyTorch framework, whereas in other embodiments, training framework 704 is a TensorFlow, Boost, Caffe, Microsoft Cognitive Toolkit/CNTK, MXNet, Chainer, Keras, Deeplearning4j, or other training framework. In at least one embodiment, training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having a known output and an output of neural network 706 is manually graded. In at least one embodiment, untrained neural network 706 is trained in a supervised manner and processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on input data such as a new dataset 714. In at least one embodiment, training framework 704 trains untrained neural network 706 repeatedly while adjusting weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, whereas untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map in trained neural network 708 capable of performing operations useful in reducing dimensionality of new dataset 714. In at least one embodiment, unsupervised training can also be used to perform anomaly detection, which allows identification of data points in new dataset 714 that deviate from normal patterns of new dataset 714.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new dataset 714 with out forgetting knowledge instilled within trained neural network 708 during initial training.

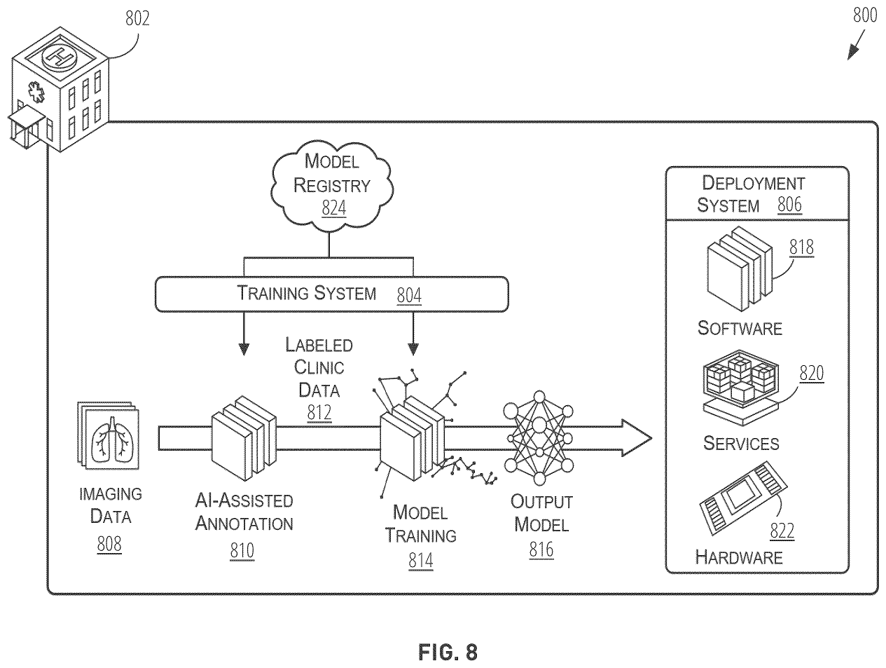

With reference to FIG. 8, FIG. 8 is an example data flow diagram for a process 800 of generating and deploying a processing and inferencing pipeline, according to at least one embodiment. In at least one embodiment, process 800 may be deployed to perform game name recognition analysis and inferencing on user feedback data at one or more facilities 802, such as a data center.

In at least one embodiment, process 800 may be executed within a training system 804 and/or a deployment system 806. In at least one embodiment, training system 804 may be used to perform training, deployment, and embodiment of machine learning models (e.g., neural networks, object detection algorithms, computer vision algorithms, etc.) for use in deployment system 806. In at least one embodiment, deployment system 806 may be configured to offload processing and compute resources among a distributed computing environment to reduce infrastructure requirements at facility 802. In at least one embodiment, deployment system 806 may provide a streamlined platform for selecting, customizing, and implementing virtual instruments for use with computing devices at facility 802. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 806 during execution of applications.

In at least one embodiment, some applications used in advanced processing and inferencing pipelines may use machine learning models or other AI to perform one or more processing steps. In at least one embodiment, machine learning models may be trained at facility 802 using feedback data 808 (such as imaging data) stored at facility 802 or feedback data 808 from another facility or facilities, or a combination thereof. In at least one embodiment, training system 804 may be used to provide applications, services, and/or other resources for generating working, deployable machine learning models for deployment system 806.

In at least one embodiment, a model registry 800 may be backed by object storage that may support versioning and object metadata. In at least one embodiment, object storage may be accessible through, for example, a cloud storage (e.g., a cloud 916 of FIG. 12) compatible application programming interface (API) from within a cloud platform. In at least one embodiment, machine learning models within model registry 800 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 806 (FIG. 12) may include a scenario where facility 802 is training their own machine learning model, or has an existing machine learning model that needs to be optimized or updated. In at least one embodiment, feedback data 808 may be received from various channels, such as forums, web forms, or the like. In at least one embodiment, once feedback data 808 is received, AI-assisted annotation 810 may be used to aid in generating annotations corresponding to feedback data 808 to be used as ground truth data for a machine learning model. In at least one embodiment, AI-assisted annotation 810 may include one or more machine learning models (e.g., convolutional neural networks (CNNs)) that may be trained to generate annotations corresponding to certain types of feedback data 808 (e.g., from certain devices) and/or certain types of anomalies in feedback data 808. In at least one embodiment, AI-assisted annotations 810 may then be used directly, or may be adjusted or fine-tuned using an annotation tool, to generate ground truth data. In at least one embodiment, in some examples, labeled data 812 may be used as ground truth data for training a machine learning model. In at least one embodiment, AI-assisted annotations 810, labeled data 812, or a combination thereof may be used as ground truth data for training a machine learning model, e.g., via model training 814 in FIGS. 6-7. In at least one embodiment, a trained machine learning model may be referred to as an output model 816, and may be used by deployment system 806, as described herein.

In at least one embodiment, training pipeline 806 (FIG. 9) may include a scenario where facility 802 needs a machine learning model for use in performing one or more processing tasks for one or more applications in deployment system 806, but facility 802 may not currently have such a machine learning model (or may not have a model that is optimized, efficient, or effective for such purposes). In at least one embodiment, an existing machine learning model may be selected from model registry 800. In at least one embodiment, model registry 800 may include machine learning models trained to perform a variety of different inference tasks on imaging data. In at least one embodiment, machine learning models in model registry 800 may have been trained on imaging data from different facilities than facility 802 (e.g., facilities that are remotely located). In at least one embodiment, machine learning models may have been trained on imaging data from one location, two locations, or any number of locations. In at least one embodiment, when being trained on imaging data, which may be a form of feedback data 808, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 800. In at least one embodiment, a machine learning model may then be retrained, or updated, at any number of other facilities, and a retrained or updated model may be made available in model registry 800. In at least one embodiment, a machine learning model may then be selected from model registry 800—and referred to as output model 816—and may be used in deployment system 806 to perform one or more processing tasks for one or more applications of a deployment system.

In at least one embodiment, training pipeline 806 (FIG. 9) may be used in a scenario that includes facility 802 requiring a machine learning model for use in performing one or more processing tasks for one or more applications in deployment system 806, but facility 802 may not currently have such a machine learning model (or may not have a model that is optimized, efficient, or effective for such purposes). In at least one embodiment, a machine learning model selected from model registry 800 might not be fine-tuned or optimized for feedback data 808 generated at facility 802 because of differences in populations, genetic variations, robustness of training data used to train a machine learning model, diversity in anomalies of training data, and/or other issues with training data. In at least one embodiment, AI-assisted annotation 810 may be used to aid in generating annotations corresponding to feedback data 808 to be used as ground truth data for retraining or updating a machine learning model. In at least one embodiment, labeled data 812 may be used as ground truth data for training a machine learning model. In at least one embodiment, retraining or updating a machine learning model may be referred to as model training 814. In at least one embodiment, model training 814—e.g., AI-assisted annotations 810, labeled data 812, or a combination thereof—may be used as ground truth data for retraining or updating a machine learning model.

In at least one embodiment, deployment system 806 may include software 818, services 820, hardware 822, and/or other components, features, and functionality. In at least one embodiment, deployment system 806 may include a software “stack,” such that software 818 may be built on top of services 820 and may use services 820 to perform some or all of processing tasks, and services 820 and software 818 may be built on top of hardware 822 and use hardware 822 to execute processing, storage, and/or other compute tasks of deployment system 806.

In at least one embodiment, software 818 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 808 (or other data types, such as those described herein). In at least one embodiment, an advanced processing and inferencing pipeline may be defined based on selections of different containers that are desired or required for processing feedback data 808, in addition to containers that receive and configure imaging data for use by each container and/or for use by facility 802 after processing through a pipeline (e.g., to convert outputs back to a usable data type for storage and display at facility 802). In at least one embodiment, a combination of containers within software 818 (e.g., that make up a pipeline) may be referred to as a virtual instrument (as described in more detail herein), and a virtual instrument may leverage services 820 and hardware 822 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 816 of training system 804.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 800 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 820 as a system (e.g., system 900 of FIG. 9). In at least one embodiment, once validated by system 900 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 900 of FIG. 9). In at least one embodiment, completed and validated applications or containers may be stored in a container registry and associated machine learning models may be stored in model registry 800. In at least one embodiment, a requesting entity that provides an inference or image processing request may browse a container registry and/or model registry 800 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 806 (e.g., a cloud) to perform processing of a data processing pipeline. In at least one embodiment, processing by deployment system 806 may include referencing selected elements (e.g., applications, containers, models, etc.) from a container registry and/or model registry 800. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 820 may be leveraged. In at least one embodiment, services 820 may include compute services, collaborative content creation services, simulation services, artificial intelligence (AI) services, visualization services, and/or other service types. In at least one embodiment, services 820 may provide functionality that is common to one or more applications in software 818, so functionality may be abstracted to a service that may be called upon or leveraged by applications. In at least one embodiment, functionality provided by services 820 may run dynamically and more efficiently, while also scaling well by allowing applications to process data in parallel, e.g., using a parallel computing platform 920 (FIG. 9). In at least one embodiment, rather than each application that shares a same functionality offered by a service 820 being required to have a respective instance of service 820, service 820 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 820 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 818 implementing advanced processing and inferencing pipeline may be streamlined because each application may call upon the same inference service to perform one or more inferencing tasks.

In at least one embodiment, hardware 822 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 822 may be used to provide efficient, purpose-built support for software 818 and services 820 in deployment system 806. In at least one embodiment, use of GPU processing may be implemented for processing locally (e.g., at facility 802), within an AI/deep learning system, in a cloud system, and/or in other processing components of deployment system 806 to improve efficiency, accuracy, and efficacy of game name recognition.

In at least one embodiment, software 818 and/or services 820 may be optimized for GPU processing with respect to deep learning, machine learning, and/or high-performance computing, simulation, and visual computing, as non-limiting examples. In at least one embodiment, at least some of the computing environment of deployment system 806 and/or training system 804 may be executed in a datacenter or one or more supercomputers or high performance computing systems, with GPU-optimized software (e.g., hardware and software combination of NVIDIA's DGX™ system). In at least one embodiment, hardware 822 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 9 is a system diagram for an example system 900 for generating and deploying a deployment pipeline, according to at least one embodiment. In at least one embodiment, system 1200 may be used to implement process 800 of FIG. 6 and/or other processes including advanced processing and inferencing pipelines. In at least one embodiment, system 900 may include training system 804 and deployment system 806. In at least one embodiment, training system 804 and deployment system 806 may be implemented using software 818, services 1120, and/or hardware 822, as described herein.

In at least one embodiment, system 900 (e.g., training system 804 and/or deployment system 806) may implemented in a cloud computing environment (e.g., using cloud 916). In at least one embodiment, system 900 may be implemented locally with respect to a facility, or as a combination of both cloud and local computing resources. In at least one embodiment, access to APIs in cloud 916 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 900, may be restricted to a set of public internet service providers (ISPs) that have been vetted or authorized for interaction.

In at least one embodiment, various components of system 900 may communicate between and among one another using any of a variety of different network types, including but not limited to local area networks (LANs) and/or wide area networks (WANs) via wired and/or wireless communication protocols. In at least one embodiment, communication between facilities and components of system 900 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 804 may execute training pipelines 806, similar to those described herein with respect to FIG. 6. In at least one embodiment, where one or more machine learning models are to be used in deployment pipelines 816 by deployment system 806, training pipelines 806 may be used to train or retrain one or more (e.g., pre-trained) models, and/or implement one or more of pre-trained models 810 (e.g., without a need for retraining or updating). In at least one embodiment, as a result of training pipelines 806, output model(s) 816 may be generated. In at least one embodiment, training pipelines 806 may include any number of processing steps, AI-assisted annotation 810, labeling or annotating of feedback data 808 to generate labeled data 812, model selection from a model registry, model training 814, training, retraining, or updating models, and/or other processing steps. In at least one embodiment, for different machine learning models used by deployment system 806, different training pipelines 806 may be used. In at least one embodiment, training pipeline 806, similar to a first example described with respect to FIG. 6, may be used for a first machine learning model, training pipeline 806, similar to a second example described with respect to FIG. 6, may be used for a second machine learning model, and training pipeline 806, similar to a third example described with respect to FIG. 6, may be used for a third machine learning model. In at least one embodiment, any combination of tasks within training system 804 may be used depending on what is required for each respective machine learning model. In at least one embodiment, one or more of machine learning models may already be trained and ready for deployment so machine learning models may not undergo any processing by training system 804, and may be implemented by deployment system 806.

In at least one embodiment, output model(s) 816 and/or pre-trained model(s) 810 may include any types of machine learning models depending on embodiment. In at least one embodiment, and without limitation, machine learning models used by system 900 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 806 may include AI-assisted annotation. In at least one embodiment, labeled data 812 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 808 (or other data type used by machine learning models), there may be corresponding ground truth data generated by training system 804. In at least one embodiment, AI-assisted annotation may be performed as part of deployment pipelines 816; either in addition to, or in lieu of, AI-assisted annotation included in training pipelines 806. In at least one embodiment, system 900 may include a multi-layer platform that may include a software layer (e.g., software 818) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 802. In at least one embodiment, applications may then call or execute one or more services 820 for performing compute, AI, or visualization tasks associated with respective applications, and software 818 and/or services 820 may leverage hardware 822 to perform processing tasks in an effective and efficient manner.

In at least one embodiment, deployment system 806 may execute deployment pipelines 816. In at least one embodiment, deployment pipelines 816 may include any number of applications that may be sequentially, non-sequentially, or otherwise applied to feedback data (and/or other data types), including AI-assisted annotation, as described above. In at least one embodiment, as described herein, a deployment pipeline 816 for an individual device may be referred to as a virtual instrument for a device. In at least one embodiment, for a single device, there may be more than one deployment pipeline 816 depending on information desired from data generated by a device.

In at least one embodiment, applications available for deployment pipelines 816 may include any application that may be used for performing processing tasks on feedback data or other data from devices. In at least one embodiment, because various applications may share common image operations, in some embodiments, a data augmentation library (e.g., as one of services 820) may be used to accelerate these operations. In at least one embodiment, to avoid bottlenecks of conventional processing approaches that rely on CPU processing, parallel computing platform 920 may be used for GPU acceleration of these processing tasks.

In at least one embodiment, deployment system 806 may include a user interface (UI) 902b (e.g., a graphical user interface, a web interface, etc.) that may be used to select applications for inclusion in deployment pipeline(s) 816, arrange applications, modify or change applications or parameters or constructs thereof, use and interact with deployment pipeline(s) 816 during set-up and/or deployment, and/or to otherwise interact with deployment system 806. In at least one embodiment, although not illustrated with respect to training system 804, UI 902b (or a different user interface) may be used for selecting models for use in deployment system 806, for selecting models for training, or retraining, in training system 804, and/or for otherwise interacting with training system 804. In at least one embodiment, training system 804 and deployment system 806 may include DICOM adapters 902A and 902B.

In at least one embodiment, pipeline manager 902a may be used, in addition to an application orchestration system 728, to manage interaction between applications or containers of deployment pipeline(s) 816 and services 820 and/or hardware 822. In at least one embodiment, pipeline manager 902a may be configured to facilitate interactions from application to application, from application to service 820, and/or from application or service to hardware 822. In at least one embodiment, although illustrated as included in software 818, this is not intended to be limiting, and in some examples pipeline manager 902a may be included in services 820. In at least one embodiment, application orchestration system 728 (e.g., Kubernetes, DOCKER, etc.) may include a container orchestration system that may group applications into containers as logical units for coordination, management, scaling, and deployment. In at least one embodiment, by associating applications from deployment pipeline(s) 816 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 902a and application orchestration system 728. In at least one embodiment, so long as an expected input and/or output of each container or application is known by a system (e.g., based on constructs of applications or containers), application orchestration system 728 and/or pipeline manager 902a may facilitate communication among and between, and sharing of resources among and between, each of applications or containers. In at least one embodiment, because one or more of applications or containers in deployment pipeline(s) 816 may share the same services and resources, application orchestration system 728 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 728) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 820 leveraged and shared by applications or containers in deployment system 806 may include compute services 904, collaborative content creation services 917, AI services 906, simulation services 919, visualization services 910, and/or other service types. In at least one embodiment, applications may call (e.g., execute) one or more of services 820 to perform processing operations for an application. In at least one embodiment, compute services 904 may be leveraged by applications to perform super-computing or other high-performance computing (HPC) tasks. In at least one embodiment, compute service(s) 904 may be leveraged to perform parallel processing (e.g., using a parallel computing platform 920) for processing data through one or more of applications and/or one or more tasks of a single application, substantially simultaneously. In at least one embodiment, parallel computing platform 920 (e.g., NVIDIA's CUDA®) may enable general purpose computing on GPUs (GPGPU) (e.g., GPUs 912). In at least one embodiment, a software layer of parallel computing platform 920 may provide access to virtual instruction sets and parallel computational elements of GPUs, for execution of compute kernels. In at least one embodiment, parallel computing platform 920 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 920 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 906 may be leveraged to perform inferencing services for executing machine learning model(s) associated with applications (e.g., tasked with performing one or more processing tasks of an application). In at least one embodiment, AI services 906 may leverage AI system 914 to execute machine learning model(s) (e.g., neural networks, such as CNNs) for segmentation, reconstruction, object detection, feature detection, classification, and/or other inferencing tasks. In at least one embodiment, applications of deployment pipeline(s) 816 may use one or more of output models 816 from training system 804 and/or other models of applications to perform inference on imaging data (e.g., DICOM data, RIS data, CIS data, REST compliant data, RPC data, raw data, etc.). In at least one embodiment, two or more examples of inferencing using application orchestration system 918 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 918 may distribute resources (e.g., services 820 and/or hardware 822) based on priority paths for different inferencing tasks of AI services 906.

In at least one embodiment, shared storage may be mounted to AI services 906 within system 1200. In at least one embodiment, shared storage may operate as a cache (or other storage device type) and may be used to process inference requests from applications. In at least one embodiment, when an inference request is submitted, a request may be received by a set of API instances of deployment system 806, and one or more instances may be selected (e.g., for best fit, for load balancing, etc.) to process a request. In at least one embodiment, to process a request, a request may be entered into a database, a machine learning model may be located from model registry 800 if not already in a cache, a validation step may ensure appropriate machine learning model is loaded into a cache (e.g., shared storage), and/or a copy of a model may be saved to a cache. In at least one embodiment, the scheduler (e.g., of pipeline manager 902a) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 1120 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 916, and an inference service may perform inferencing on a GPU.

In at least one embodiment, visualization services 910 may be leveraged to generate visualizations for viewing outputs of applications and/or deployment pipeline(s) 816. In at least one embodiment, GPUs 912 may be leveraged by visualization services 910 to generate visualizations. In at least one embodiment, rendering effects, such as ray-tracing or other light transport simulation techniques, may be implemented by visualization services 910 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 910 may include an internal visualizer, cinematics, and/or other rendering or image processing capabilities or functionality (e.g., ray tracing, rasterization, internal optics, etc.).

In at least one embodiment, hardware 822 may include GPUs 912, AI system 914, cloud 916, and/or any other hardware used for executing training system 804 and/or deployment system 806. In at least one embodiment, GPUs 912 (e.g., NVIDIA's TESLA® and/or QUADRO® GPUs) may include any number of GPUs that may be used for executing processing tasks of compute services 904, collaborative content creation services 917, AI services 906, simulation services 1219, visualization services 910, other services, and/or any of features or functionality of software 818. For example, with respect to AI services 906, GPUs 912 may be used to perform pre-processing on imaging data (or other data types used by machine learning models), post-processing on outputs of machine learning models, and/or to perform inferencing (e.g., to execute machine learning models). In at least one embodiment, cloud 916, AI system 914, and/or other components of system 1200 may use GPUs 912. In at least one embodiment, cloud 916 may include a GPU-optimized platform for deep learning tasks. In at least one embodiment, AI system 914 may use GPUs, and cloud 916—or at least a portion tasked with deep learning or inferencing—may be executed using one or more AI systems 914. As such, although hardware 822 is illustrated as discrete components, this is not intended to be limiting, and any components of hardware 822 may be combined with, or leveraged by, any other components of hardware 822.

In at least one embodiment, AI system 914 may include a purpose-built computing system (e.g., a super-computer or an HPC) configured for inferencing, deep learning, machine learning, and/or other artificial intelligence tasks. In at least one embodiment, AI system 914 (e.g., NVIDIA's DGX™) may include GPU-optimized software (e.g., a software stack) that may be executed using a plurality of GPUs 912, in addition to CPUs, RAM, storage, and/or other components, features, or functionality. In at least one embodiment, one or more AI systems 914 may be implemented in cloud 916 (e.g., in a data center) for performing some or all of AI-based processing tasks of system 1200.

In at least one embodiment, cloud 916 may include a GPU-accelerated infrastructure (e.g., NVIDIA's NGC™) that may provide a GPU-optimized platform for executing processing tasks of system 1200. In at least one embodiment, cloud 916 may include an AI system(s) 914 for performing one or more of AI-based tasks of system 1200 (e.g., as a hardware abstraction and scaling platform). In at least one embodiment, cloud 916 may integrate with application orchestration system 918 leveraging multiple GPUs to enable seamless scaling and load balancing between and among applications and services 820. In at least one embodiment, cloud 916 may be tasked with executing at least some of services 820 of system 1200, including compute services 904, AI services 906, and/or visualization services 910, as described herein. In at least one embodiment, cloud 916 may perform small and large batch inference (e.g., executing NVIDIA's TensorRT™), provide an accelerated parallel computing API and platform 920 (e.g., NVIDIA's CUDA®), execute application orchestration system 728 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1200.

In at least one embodiment, in an effort to preserve patient confidentiality (e.g., where patient data or records are to be used off-premises), cloud 916 may include a registry, such as a deep learning container registry. In at least one embodiment, a registry may store containers for instantiations of applications that may perform pre-processing, post-processing, or other processing tasks on patient data. In at least one embodiment, cloud 916 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures-such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g., updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

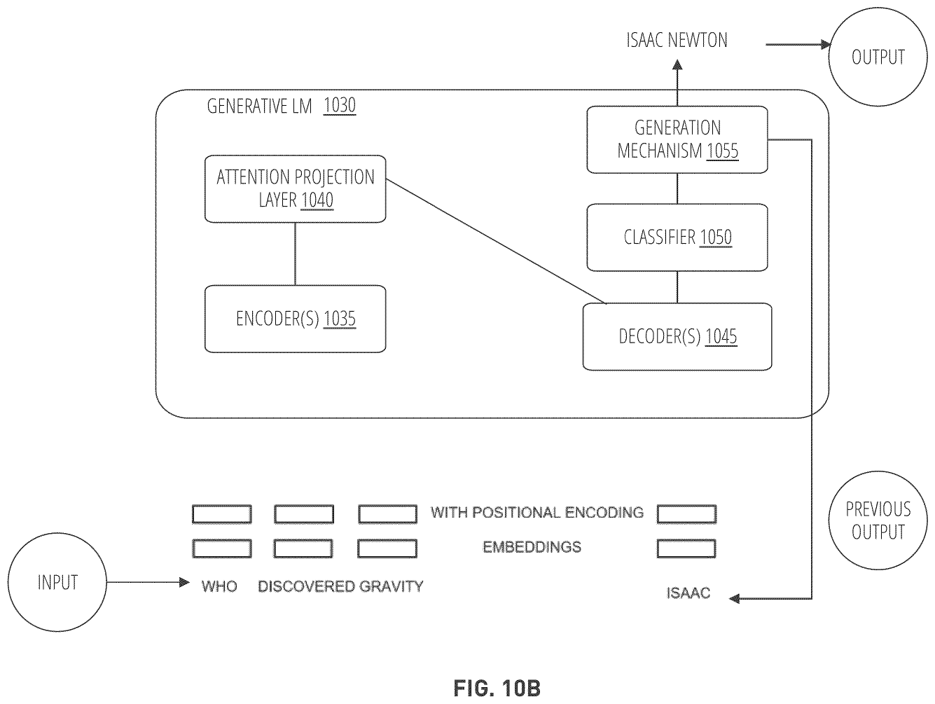

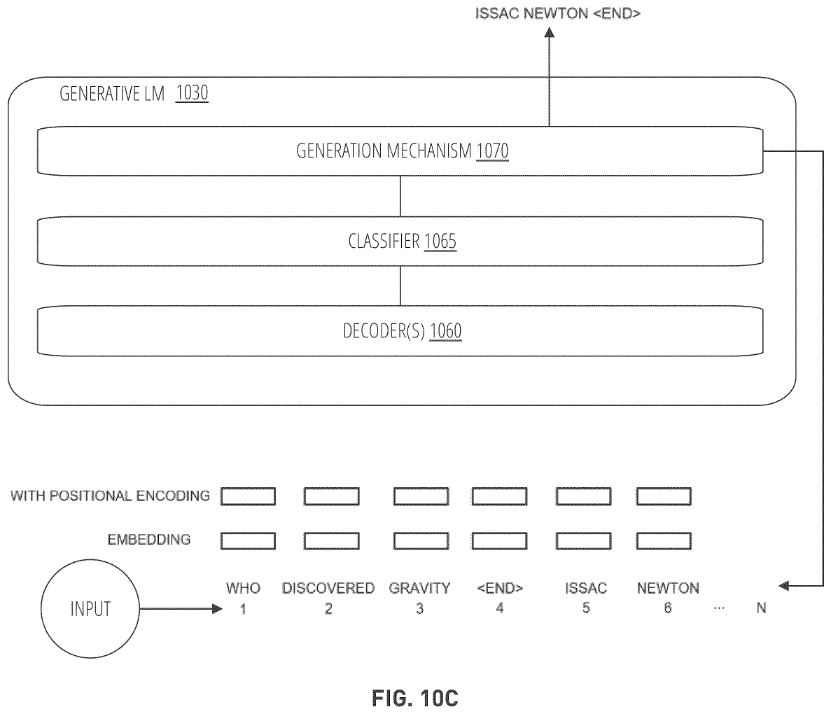

FIG. 10A is a block diagram of an example generative language model system 1300 suitable for use in implementing at least some embodiments of the present disclosure. In the example illustrated in FIG. 10A, the generative language model system 1300 includes a retrieval augmented generation (RAG) component 1092, an input processor 1005, a tokenizer 1010, an embedding component 1020, plug-ins/APIs 1095, and a generative language model (LM) 1030 (which may include an LLM, a SLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1030 (e.g., LLM/SLMs/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/SLMs/VLM/MMLM/etc. with external knowledge, so that answers to specific questions or queries or requests are more relevant-such as in a case where specific knowledge is required. The RAG component 1092 may fetch this additional information (e.g., grounding information, such as grounding text/image/video/audio/USD/CAD/etc.) from one or more external sources, which can then be fed to the LLM/SLMs/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval, and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLMs/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLMs/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLMs/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1030 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1035 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1035 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1035 may use any known technique to extract and encode audio features-such as in the form of a spectrogram (e.g., a mel-spectrogram). In some implementations in which the input 1001 includes video data, the input processor 1001 may extract frames or apply resizing to extracted frames, and the embedding component 1035 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1035 of FIG. 10A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

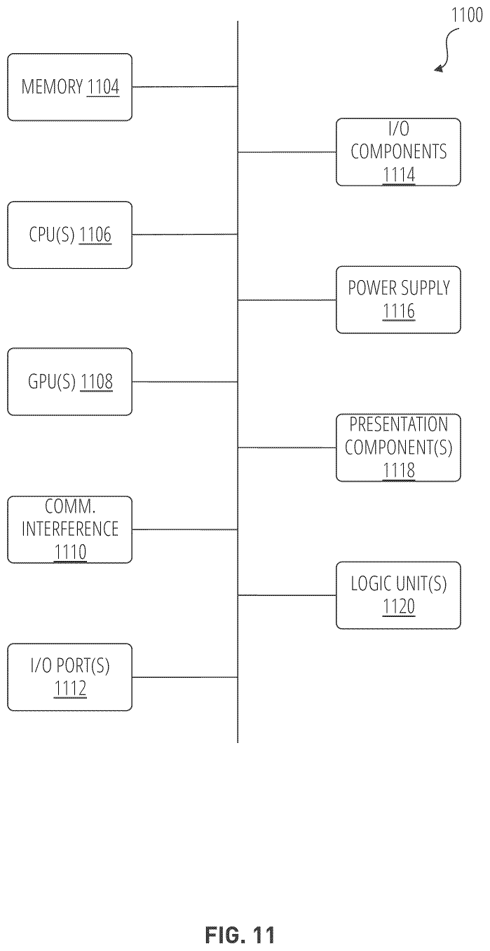

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1402 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1104 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1402 may include a PCIe link to carry out the connection. In these examples, a PCI bus need not be included in the computing device 1100.

The memory 1106 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1106 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1108 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1108, the GPU(s) 1110 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1108 and/or the GPU(s) 1110, the logic unit(s) 1100 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes, and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1100 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1112 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1402 directly to (e.g., a memory of) one or more GPU(s) 1108.

The I/O ports 1114 may allow the computing device 1100 to be logically coupled to other devices including the I/O components 1116, the presentation component(s) 1120, and/or other components, some of which may be built in to (e.g., integrated in) the computing device 1100. Illustrative I/O components 1116 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1118 may include a hard-wired power supply, a battery power supply, or a combination thereof. The power supply 1116 may provide power to the computing device 1100 to allow the components of the computing device 1100 to operate.

The presentation component(s) 1120 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

What is claimed is:

1. A method comprising:
generating, by at least one processor, a plurality of input options for performing each task of a plurality of tasks by a first generative AI model;
analyzing, by the at least one processor, a plurality of outputs produced by the first generative AI model for each task of the plurality of tasks based on respective input options of the plurality of input options;
comparing, by the at least one processor, first performance data reflecting a first subset of input options selected from the plurality of input options used by the first generative AI model for at least one task of the plurality of tasks and second performance data reflecting a second subset of input options used by a second generative AI model for the at least one task;
generating, by the at least one processor and based on a comparison of the first performance data and the second performance data, a recommendation related to a use of the first generative AI model; and
causing the recommendation to be performed with respect to the first generative AI model.

2. The method of claim 1, wherein the first subset of input options corresponds to the second subset of input options.

3. The method of claim 2, wherein:
the first performance data is user demand data for the at least one task, a first average number of sub-inputs for each input option of the first subset of input options for the at least one task, and a first output accuracy metric for each input option of the first subset of input options for the at least one task; and
the second performance data is user demand data for the at least one task, a second average number of sub-inputs for each input option of the second subset of input options for the at least one task, and a second output accuracy metric for each input option of the second subset of input options for the at least one task.

4. The method of claim 1, wherein the recommendation related to the use of the first generative AI model includes at least one of removing the at least one task of the first generative AI model, preventing computing resources from being assigned to self-improvement of the at least one task, or setting a price per token for the plurality of tasks.

5. The method of claim 1, wherein the at least one task includes a first task and a second task.

6. The method of claim 5, wherein comparing the first performance data reflecting the first subset of input options selected from the plurality of input options used by the first generative AI model for the at least one task of the plurality of tasks and the second performance data reflecting the second subset of input options used by the second generative AI model for the at least one task further comprises:
determining the first performance data for each of the first task of the first generative AI model and the second task of the first generative AI model and the second performance data for the first task of the second generative AI model and the second task of the second generative AI model; and
based on the first performance data and the second performance data, ranking the first task and the second task of the first generative AI model.

7. The method of claim 1, wherein the recommendation comprises one or more operations to be performed with respect to the first generative AI model, the method further comprising causing the one or more operations of the recommendation to be performed with respect to the first generative AI model.

8. A computing system comprising:
a memory; and
one or more processors, coupled to the memory, to:
generate a plurality of input options for performing each task of a plurality of tasks by a first generative AI model;
analyze a plurality of outputs produced by the first generative AI model for each task of the plurality of tasks;
compare first performance data reflecting a first subset of input options selected from the plurality of input options used by the first generative AI model for at least one task of the plurality of tasks and second performance data reflecting a second subset of input options used by a second generative AI model for the at least one task;
generate, based on a comparison of the first performance data and the second performance data, a recommendation related to a use of the first generative AI model; and
cause the recommendation to be performed with respect to the first generative AI model.

9. The computing system of claim 8, wherein the first subset of input options corresponds to the second subset of input options.

10. The computing system of claim 9, wherein:
the first performance data is user demand data for the at least one task, a first average number of sub-inputs for each input option of the first subset of input options for the at least one task, and a first output accuracy metric for each input option of the first subset of input options for the at least one task; and
the second performance data is user demand data for the at least one task, a second average number of sub-inputs for each input option of the second subset of input options for the at least one task, and a second output accuracy metric for each input option of the second subset of input options for the at least one task.

11. The computing system of claim 8, wherein the recommendation related to the use of the first generative AI model includes at least one of removing the at least one task of the first generative AI model, preventing computing resources from being assigned to self-improvement of the at least one task, or setting a price per token for the plurality of tasks.

12. The computing system of claim 8, wherein the at least one task includes a first task and a second task.

13. The computing system of claim 12, wherein to compare the first performance data reflecting the first subset of input options selected from the plurality of input options used by the first generative AI model for the at least one task of the plurality of tasks and the second performance data reflecting the second subset of input options used by the second generative AI model for the at least one task, the one or more processors are further to:
determine the first performance data for each of the first task of the first generative AI model and the second task of the first generative AI model and the second performance data for the first task of the second generative AI model and the second task of the second generative AI model; and
based on the first performance data and the second performance data, rank the first task and the second task of the first generative AI model.

14. The computing system of claim 8, wherein the recommendation comprises one or more operations to be performed with respect to the first generative AI model, and the one or more processors are further to cause the one or more operations of the recommendation to be performed with respect to the first generative AI model.

15. One or more processors comprising:
processing circuitry to:
analyze a plurality of outputs produced by a first generative AI model for using a plurality of input options for performing each task of a plurality of tasks;
compare first performance data reflecting a first subset of input options selected from the plurality of input options used by the first generative AI model for at least one task of the plurality of tasks and second performance data reflecting a second subset of input options used by a second generative AI model for the at least one task;
generate, based on a comparison of the first performance data and the second performance data, a recommendation related to a use of the first generative AI model;
cause the recommendation to be performed with respect to the first generative AI model.

16. The one or more processors of claim 15, wherein the first subset of input options corresponds to the second subset of input options.

17. The one or more processors of claim 16, wherein:
the first performance data is user demand data for the at least one task, a first average number of sub-inputs for each input option of the first subset of input options for the at least one task, and a first output accuracy metric for each input option of the first subset of input options for the at least one task; and
the second performance data is user demand data for the at least one task, a second average number of sub-inputs for each input option of the second subset of input options for the at least one task, and a second output accuracy metric for each input option of the second subset of input options for the at least one task.

18. The one or more processors of claim 15, wherein the recommendation related to the use of the first generative AI model includes at least one of removing the at least one task of the first generative AI model, preventing computing resources from being assigned to self-improvement of the at least one task, or setting a price per token for the plurality of tasks.

19. The one or more processors of claim 15, wherein the at least one task includes a first task and a second task.

20. The one or more processors of claim 19, wherein to compare the first performance data reflecting the first subset of input options selected from the plurality of input options used by the first generative AI model for the at least one task of the plurality of tasks and the second performance data reflecting the second subset of input options used by the second generative AI model for the at least one task, the one or more processors are further to:
determine the first performance data for each of the first task of the first generative AI model and the second task of the first generative AI model and the second performance data for the first task of the second generative AI model and the second task of the second generative AI model; and
based on the first performance data and the second performance data, rank the first task and the second task of the first generative AI model.
